(19) United States
(12) Patent Application Publication
(10) Pub. No.: US 2014/0332649 A1
(43) Pub. Date: Nov. 13, 2014

(54) SUPPORTING A RECYCLING BIN ON A GARBAGE CONTAINER

(71) Applicant: Brandon M. Kersey, North Port, FL (US)

(72) Inventor: Brandon M. Kersey, North Port, FL (US)

(21) Appl. No.: 14/272,024

(22) Filed: May 7, 2014

Related U.S. Application Data
(60) Provisional application No. 61/821,498, filed on May 9, 2013.

(51) Int. Cl. B65F 1/00; B23P 19/00

(52) U.S. Cl. CPC B65F 1/0066; B23P 19/00
USPC 248/304; 29/428

(57) ABSTRACT

Arrangements described herein relate to supporting one or more recycling bins on a garbage container. A hanger includes an elongated structural member comprising an upper portion configured to insert through a downward facing aperture defined on a garbage container proximate to a side of the garbage container, a hook extending from a lower portion of the elongated structural member, the hook configured to engage a transverse bar attached to the garbage container, and a first transverse member extending from the elongated structural member in a transverse orientation, the first transverse member configured to engage a first recycling bin.

### CROSS-REFERENCE TO RELATED APPLICATIONS

This application claims the benefit of Provisional Patent Application No. 61/821,498 filed on May 9, 2013, which is incorporated herein by reference.

### BACKGROUND OF THE INVENTION

Municipalities often provide recycling bins to residents of homes and apartments to facilitate collection of recyclable materials. For example, some municipalities provide to residents a recycling bin for glass and aluminum waste and another recycling bin for paper and cardboard waste. This provides the residents a reminder to recycle suitable materials, and facilitates collection of the recyclable materials.

### SUMMARY

Arrangements described herein relate to supporting one or more recycling bins on a garbage container.

In one aspect, a hanger includes an elongated structural member comprising an upper portion configured to insert through a downward facing aperture defined on a garbage container proximate to a side of the garbage container, a hook extending from a lower portion of the elongated structural member, the hook configured to engage a transverse bar attached to the garbage container, and a first transverse member extending from the elongated structural member in a transverse orientation, the first transverse member configured to engage a first recycling bin.

In another aspect, a hanger includes an elongated structural member comprising an upper portion configured to insert through a downward facing aperture defined on a garbage container proximate to a side of the garbage container, a hook extending from a lower portion of the elongated structural member, the hook configured to engage a transverse bar attached to the garbage container, the hook including a retainer to selectively retain the transverse bar, a first transverse member extending from the elongated structural member in a transverse orientation, the first transverse member configured to engage a first recycling bin, and a second transverse member extending from the elongated structural member in a transverse orientation, the second transverse member configured to support a second recycling bin.

A method includes inserting an elongated structural member of a hanger into a downward facing aperture defined on a garbage container, the downward facing aperture proximate to a side of the garbage container, engaging a hook extending from a lower portion of the elongated structural member of the hanger to a transverse bar attached to the garbage container, the transverse bar parallel to the side of the garbage container, and engaging a first recycling bin to a first transverse member, the first transverse member extending from the elongated structural member of the hanger in a transverse orientation.

### BRIEF DESCRIPTION OF THE DRAWINGS

FIG. 1 depicts a perspective view of a hanger attachable to a garbage container and configured to support recycling bins on the garbage container in accordance with one embodiment disclosed within this specification.

FIG. 2 depicts the hanger of FIG. 1 mounted to the garbage container in accordance with one embodiment disclosed within this specification.

FIG. 3 depicts a perspective view of the hanger of FIG. 1 in accordance with one embodiment disclosed within this specification.

FIG. 4 depicts a side view of the hanger of FIG. 1 in accordance with one embodiment disclosed within this specification.

FIG. 5 depicts a top view of the hanger of FIG. 1 in accordance with one embodiment disclosed within this specification.

FIG. 6 depicts a perspective view of the hanger of FIG. 1 in accordance with another embodiment disclosed within this specification.

FIG. 7 depicts a perspective view of the hanger of FIG. 6 attachable to a garbage container in accordance with another embodiment disclosed within this specification.

FIG. 8 depicts a side view of the hanger of FIG. 1 in accordance with another embodiment disclosed within this specification.

FIG. 9 depicts a perspective view of the hanger of FIG. 8 attachable to a garbage container in accordance with another embodiment disclosed within this specification.

FIG. 10 depicts recycling bins attached on the hanger of FIG. 2 when the hanger is mounted to the garbage container.

FIG. 11 depicts recycling bins attached on the hanger of FIG. 2 when the hanger is mounted to the garbage container and the garbage container is positioned for movement.

FIG. 12 depicts a perspective view of a hanger attachable to a garbage container and configured to support recycling bins on the garbage container in accordance with one embodiment disclosed within this specification.

FIG. 13 is a front view of the hanger of FIG. 12.

FIG. 14 is a side view of the hanger of FIG. 12.

FIG. 15 is a flowchart illustrating an example of a method of attaching a recycling bin to garbage container.

### DETAILED DESCRIPTION

While the specification concludes with claims defining features of the embodiments described herein that are regarded as novel, it is believed that these embodiments will be better understood from a consideration of the description in conjunction with the drawings. As required, detailed arrangements of the present embodiments are disclosed herein; however, it is to be understood that the disclosed arrangements are merely exemplary of the embodiments, which can be embodied in various forms. Therefore, specific structural and functional details disclosed herein are not to be interpreted as limiting, but merely as a basis for the claims and as a representative basis for teaching one skilled in the art to variously employ the present embodiments in virtually any appropriately detailed structure. Further, the terms and phrases used herein are not intended to be limiting but rather to provide an understandable description of the present arrangements.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

Arrangements described herein relate to supporting one or more recycling bins on a garbage container. More particularly, a hanger can be mounted on an existing garbage container without requiring modifications to the garbage container, and without interfering with opening and/or closing of the garbage container's lid. When the hanger is mounted to the garbage container, one or more recycling bins can be brought into engagement with the hanger, such as by hanging the recycling bins thereon. In this regard, the hanger can support the recycling bins on the garbage container. Thus, when the garbage container is moved, by virtue of their mounting to the garbage container, the recycling bins also can be moved.

For example, a person can hang the recycling bins on the hanger, and by moving the garbage container, also move the recycling bins to an appropriate location for garbage and recycling pickup. Once at the desired location, the person can remove the recycling bins from the hanger, and set the recycling bins on the ground or other support surface for recycling pickup. Optionally, the person also can remove the hanger from the garbage container, though this need not be the case. After the garbage container and recycling bins have been emptied, the user can again mount the recycling bins to the garbage container using the hanger and, by moving the garbage container, also move the recycling bins back to their storage location.

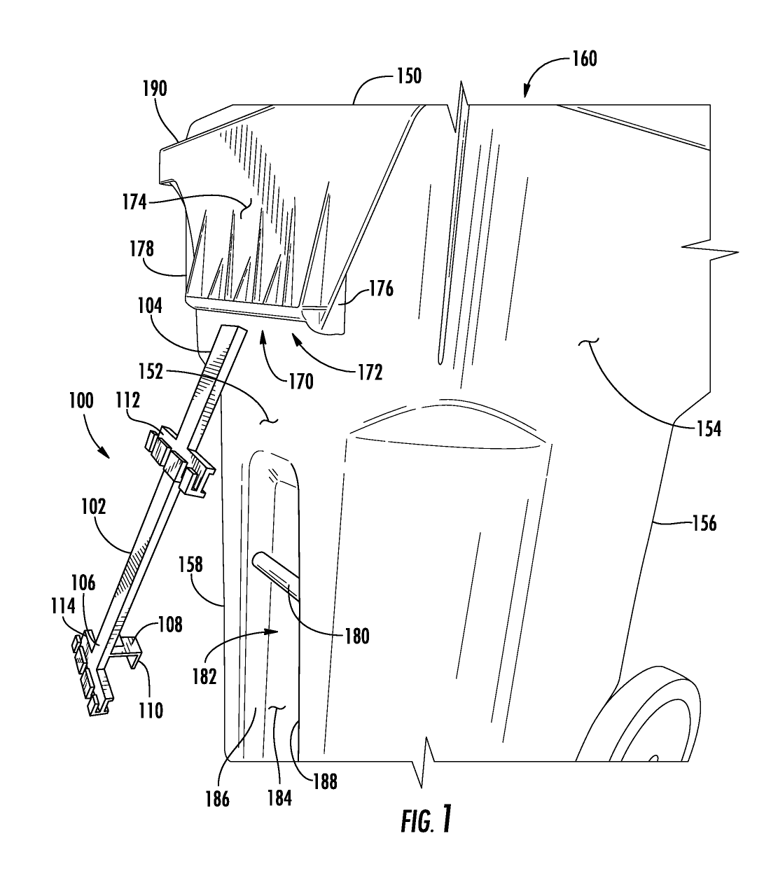

FIG. 1 depicts a hanger 100 attachable to a garbage container 150 and configured to support recycling bins on the garbage container 150, which is useful for understanding various arrangements described herein. The garbage container 150 can be a garbage container known in the art. In illustration, the garbage container 150 can include one or more sides 152. For example, in one arrangement, if the garbage container is generally cylindrical in shape, the garbage container can have a single continuous side 152 that is generally cylindrical. In another arrangement, the garbage container 150 can include a plurality of sides, for example the side 152, a side 154, a side 156 and a side 158. The side 152, or sides 152-158, can define a first cavity 160 in the garbage container 150 configured to receive garbage and/or other items.

A downward facing aperture 170 can be defined on the garbage container 150, proximate to the side 152. In one arrangement, the aperture 170 can be an opening to a second cavity 172 of the garbage container 150 that is external to the first cavity 160. The second cavity 172 can be defined by the side 152, a side member 174 spaced from side 152, and side members 176, 178 connecting the side member 174 to the side 152 and defining the aperture 170. In some arrangements, the side member 174 can be substantially parallel to the side 152. In other arrangements, the side member 174 can be non-parallel to the side 152. Nonetheless, other downward facing apertures can be used and the present arrangements are not limited in this regard.

The garbage container 150 can include a transverse bar 180. In one or more arrangements, the transverse bar 180 can be formed with the garbage container 150 so as to be a unitary structure. In one or more other arrangements, the transverse bar 180 can be one or more elements separate from the garbage container 150 and attached thereto in any suitable manner.

The garbage container 150 can include a recess 182. In one arrangement, the recess 182 can be defined in the side 152 by a rear side member 184 and substantially opposing side members 186, 188 connecting the side member 184 to the side 152. The transverse bar 180 can extend between the opposing side members 186, 188 and can extend substantially horizontally when the garbage container 150 is oriented in its intended operational position. The transverse bar 180 also can be substantially parallel to a top 190 of the garbage container 150 and/or to a bottom of the garbage container 150. The transverse bar 180 can be substantially parallel to the side member 184. As used herein, the term “substantially” includes exactly the term it modifies and slight variations therefrom. Thus, the term “substantially horizontal” means exactly horizontal and slight variations therefrom.

The hanger 100 can include an elongated structural member 102. The structural member 102 can be substantially straight, as shown in FIG. 1, or the structural member 102 can include one or more non-straight features, such as bends, curves, steps, and/or angles, just to name a few possibilities.

The structural member 102 can include an upper portion 104. The upper portion 104 can be configured to be received in the second cavity 172 through the downward facing aperture 170 defined on the garbage container 150.

The elongated structural member 102 further can include a lower portion 106. A hook 108 can extend from the lower portion 106 of the elongated structural member 102. More particularly, the hook 108 can extend from a rear side of the structural member 102. The hook 108 can be configured to engage the transverse bar 180. For example, the hook can include a downward extending tongue 110 that, when the hanger 100 is mounted on the garbage container 150, is disposed between the transverse bar 180 and the side member 184 to maintain the position of the hanger 100 on the garbage container 150. In one or more arrangements, the hook 108 can be formed with the structural member 102 as a unitary structure. In one or more arrangements, the hook 108 can be formed from one or more elements separate from the structural member 102 and attached thereto in any suitable manner, such as by one or more fasteners, one or more adhesives, one or more forms of mechanical engagement, welding, and/or brazing, just to name a few possibilities.

The hanger 100 further can include one or more transverse members. For example, the hanger 100 can include an upper transverse member 112 and a lower transverse member 114. The upper and lower transverse members 112, 114 can extend from the elongated structural member 102 in a transverse orientation. The transverse members 112, 114 can be configured to engage at least a portion of one or more recycling bins, as will be described in further detail. In one or more arrangements, the upper and/or lower transverse members 112, 114 can be formed with the structural member 102 as a unitary structure. In one or more arrangements, the upper and/or lower transverse members 112, 114 can be formed from one or more elements separate from the structural member 102 and attached thereto in any suitable manner, such as by one or more fasteners, one or more adhesives, one or more forms of mechanical engagement, welding, and/or brazing, just to name a few possibilities. The upper transverse member 112 can be substantially identical to the lower transverse member 114. However, in some arrangements, the upper transverse member 112 can be different from the lower transverse member 114 in one or more respects.

The hanger 100 can be made of plastic, metal, wood, or any other suitable material. For example, in one arrangement, the hanger 100 can be made of injection molded plastic. In another arrangement, the hanger 100 can be made of wire, such as metal wire (e.g., steel, aluminum, stainless steel, metal alloy, etc.). If the metal wire is known to corrode when exposed to adverse weather, etc., the metal wire can be provided with a protective coating known in the art. The metal wire can be made using a protrusion process to have a thickness suitable to provide adequate rigidity to support one or more recycling bins loaded with recyclable material. For example, the thickness of the wire can be from about ⅛ inch to about ½ inch. In this regard, the thickness of the wire can be selected based on the stiffness of the type of metal being used. For example, if the wire is made of steel, a thickness of about ¼ inch may be suitable. If the wire is made of stainless steel, a thickness of about 3/16 inch may be suitable. If the wire is made of aluminum, a thickness of about 5/16 inch may be suitable.

In another arrangement, the hanger 100 can be made of metal stamped to form the elongated structural member 102 and the upper and lower transverse members 112, 114. For example, the elongated structural member 102 and the upper and lower transverse members 112, 114 can be formed as components, and the upper and lower transverse members 112, 114 can be attached to the elongated structural member 102 using suitable fasteners and/or welded joints. In a further arrangement, the hanger 100 can be made of a combination of materials. For example, the elongated structural member 102 can be made of plastic, and the upper and lower transverse members 112, 114 can be made of metal (e.g., wire or stamped metal) and attached to the elongated structural member 102 using suitable fasteners.

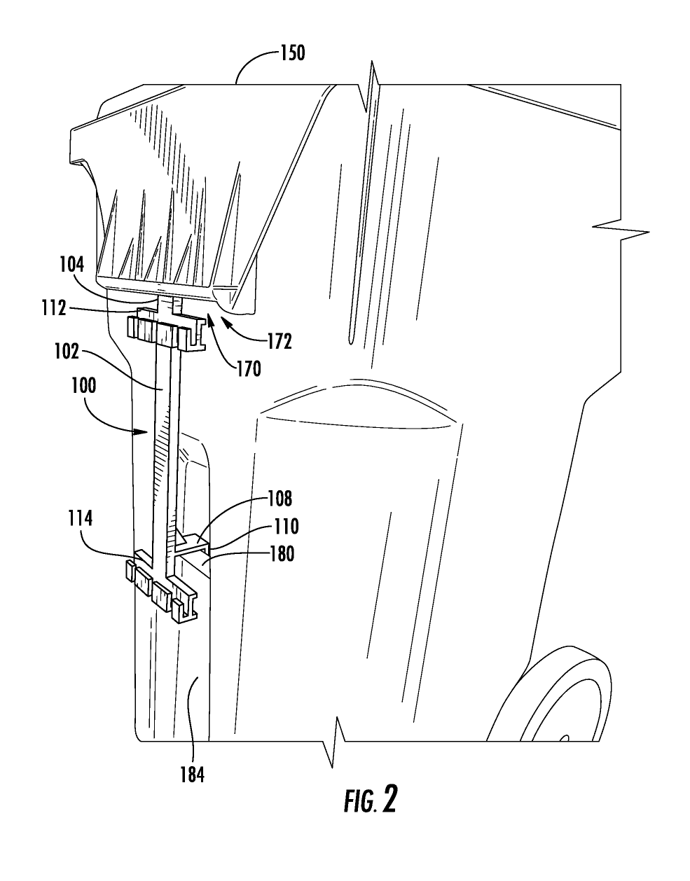

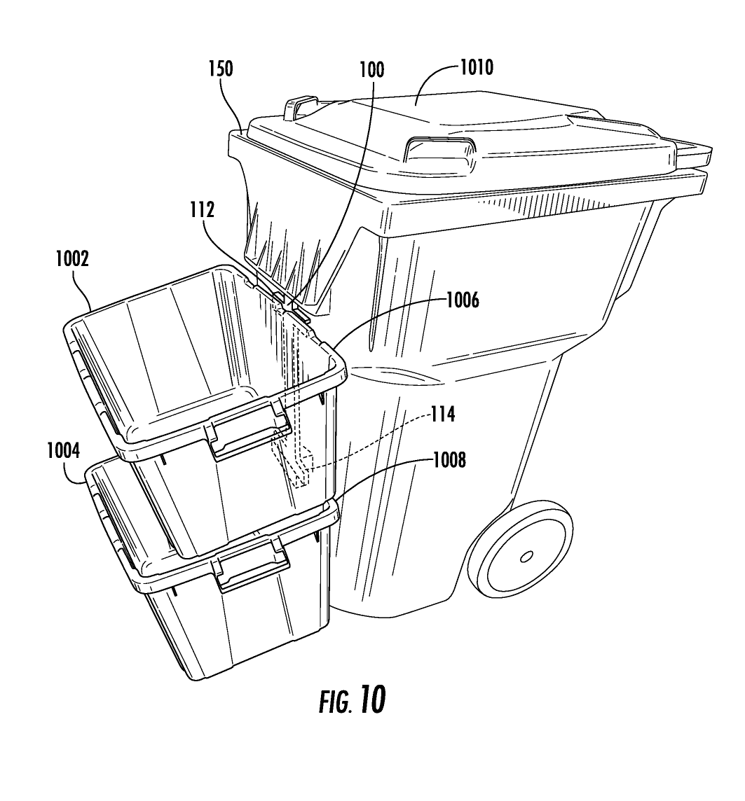

FIG. 2 depicts the hanger of FIG. 1 mounted on the garbage container. Referring to FIGS. 1 and 2, when it is desired to mount the hanger on the garbage container 150, the upper portion 104 of the elongated structural member 102 can be inserted through the downward facing aperture 170 of the garbage container 150. The upper portion 104 can be received in the second cavity 172 so that the hook 108 is disposed at a higher elevation than the transverse bar 180. The lower portion 106 of the elongated structural member 102 then can be moved toward the side member 184. The hanger then can be moved downward, toward the ground, so that the hook 108 engages the transverse bar 180 and the tongue 110 of the hook 108 is positioned between the transverse bar 180 and the side member 184 of the garbage container 150. The hanger 100 now is mounted on the garbage container 150, as shown in FIG. 2. Recycling bins 1002, 1004 can be brought into engagement with (e.g., hung on) the transverse members 112, 114, as shown in FIG. 10, such that the recycling bins 1002, 1004 are supported thereon.

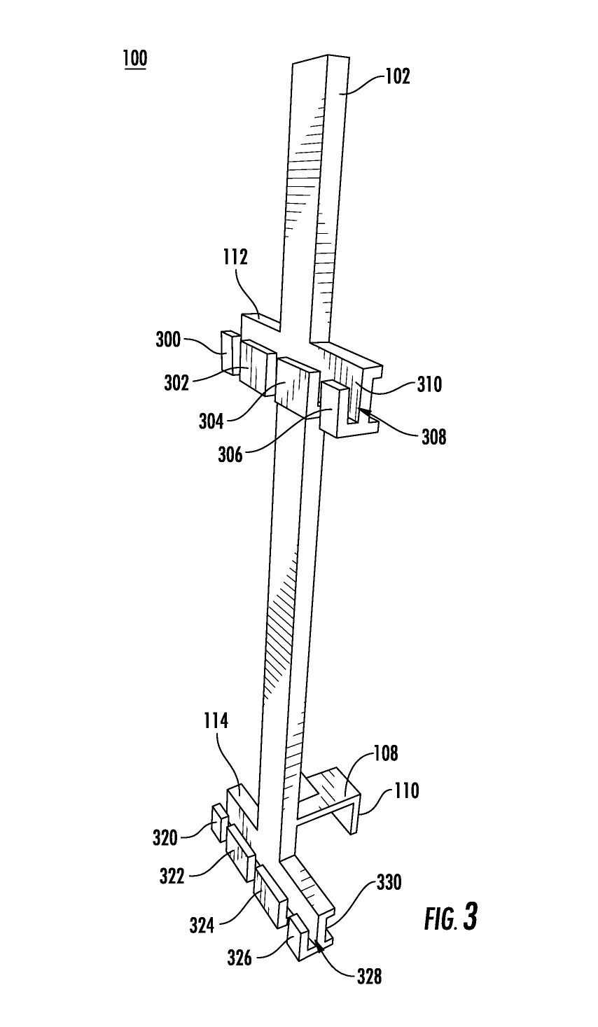

FIG. 3 depicts a perspective view of the hanger 100 of FIG. 1. The upper transverse member 112 can include a plurality of upturned fingers 300, 302, 304, 306. While FIG. 3 shows four fingers 300-306, it will be understood that arrangements are not limited to this configuration. Indeed, in some instances, there can be more than four fingers; in other instances, there can be less than four fingers. A channel 308 can be collectively defined by the fingers 300-306 and a portion of the transverse member 112 and/or the structural member 102 (e.g., surface 310).

The plurality of fingers 300-306 can be substantially identical to each other. Alternatively, one or more of the plurality of fingers 300-306 can be different from the other fingers 300-306 in one or more respects. The fingers 300-306 can be distributed in any suitable manner. For instance, the fingers 300-306 can be substantially equally spaced from each other. In one or more arrangements, one or more of neighboring pairs of the fingers 300-306 can have a different spacing relative to the other neighboring pairs of fingers.

The channel 308 can be configured to receive a lip of a first recycling bin in order to support the recycling bin. In this regard, the fingers 300-306 can be substantially L-shaped. For instance, the fingers 300-306 can extend forward from a portion of the transverse member 112 and/or the structural member 102 (e.g., surface 310). As an example, the fingers 300-306 can extend at an angle of approximately 90° relative to the surface 310. At a distance from the surface 310, the fingers 300-306 can extend upward, for example at an angle of approximately 90°, to define the channel 308. In another example, the fingers 300-306 can be curved or parabolic in shape, extending upward to define the channel 308. Similarly, the lower transverse member 114 can include a plurality of fingers 320, 322, 324, 326 configured to define a channel 328 between the fingers 320-326 and a rear member 330 to receive a lip of a second recycling bin in order to support the recycling bin. In some instances, the lip of the first recycling bin can be substantially identical to the lip of the second recycling bin. In other instances, the lip of the first recycling bin can be different from the lip of the second recycling bin in one or more respects.

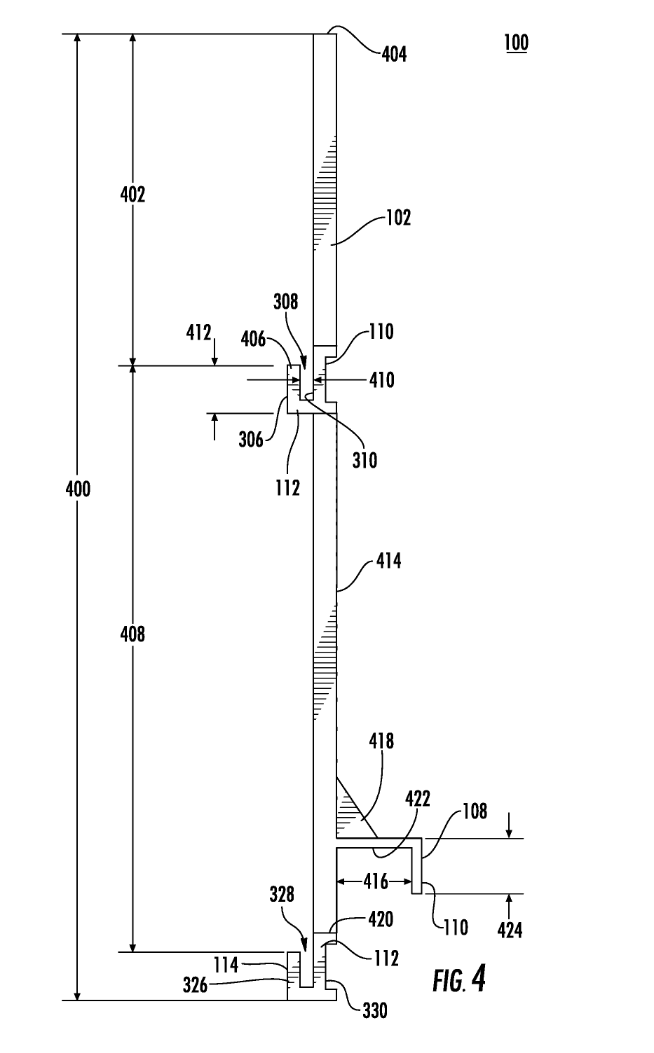

FIG. 4 depicts a side view of the hanger 100 of FIG. 1. A total length 400 of the hanger 100 can be selected for the hanger 100 to suitably mount onto the garbage container 150 of FIGS. 1 and 2. For example, the total length 400 can be from about 22 inches and about 26 inches, though the present arrangements are not limited in this regard. A distance 402 between an upper end 404 of the elongated structural member 102 and an upper end 406 of the fingers 300-306 can be from about 7 inches to about 10 inches, though, again, the present arrangements are not limited in this regard.

In one arrangement, the distance 408 between the respective positions of the upper and lower transverse members 112, 114 can be at least equal to a height of a conventional recycling bin, which can be, for example, from about 11 inches to about 16 inches. In another arrangement in which the recycling bins are configured with a top opening that is larger than a bottom of the recycling bins to allow the recycling bins to be stacked, the distance 408 between the respective positions of the upper and lower transverse members 112, 114 can be less than the height of a conventional recycling bin. In such an arrangement, a lower portion of a recycling bin engaging the upper transverse member 112 can protrude through the top opening of a recycling bin engaging the lower transverse member 114. Still, the distance 408 between the respective positions of the upper and lower transverse members 112, 114 can be any other distance suitable to allow the hanger 100 to support a first recycling bin on the upper transverse member 112 and a second recycling bin on the lower transverse member 114.

A width 410 of the channel 308 between the surface 310 and the fingers 300-306 can be, for example, from about ¼inch to about ½ inch, or any other width suitable for receiving the lip of the recycling bin. Further, a depth 412 of the channel 308 can be, for example, from about ½ inch to about 1 inch, or any other depth suitable for receiving the lip of the recycling bin. The channel 328 can have similar dimensions.

The hook 108 can extend rearward from a rear side 414 of the elongated structural member 102 at any suitable angle. For example, the hook 108 can extend at an angle of about 90° relative to the structural member 102. At a distance 416 from the rear side 414, the tongue 110 of the hook 108 can extend downward at any suitable angle. As an example, the hook 108 can extend downward at an angle of about 90°. The distance 416 can be, for example, from about 1.5 inches to about 2.5 inches, though the present arrangements are not limited in this regard. A length 424 of the tongue 110 can be, for example, from about 1 inch to about 2 inches, though the present arrangements are not limited in this regard. In other arrangements, the hook 108 can be parabolic in shape, curved in shape, or have any other shape suitable for engaging the transverse bar 180 (FIG. 1) and holding the hanger 100 in place when recycling bins are supported on the hanger 100. A structural support member (e.g., gusset 418) can structurally connect the elongated structural member 102 and the hook 108 to provide structural support to the hook 108.

The lower transverse member 114 on the elongated structural member 102 and the hook 108 can have any suitable position relative to each other. In one arrangement, the position of the lower transverse member 114 on the elongated structural member 102 can be lower than a position of the hook 108 on the elongated structural member 102, though this need not be the case. In illustration, a top side 420 of the lower transverse member 114 can be spaced from about 1 inch to about 2 inches from an opposing surface 422 of the tongue 110 of the hook 108.

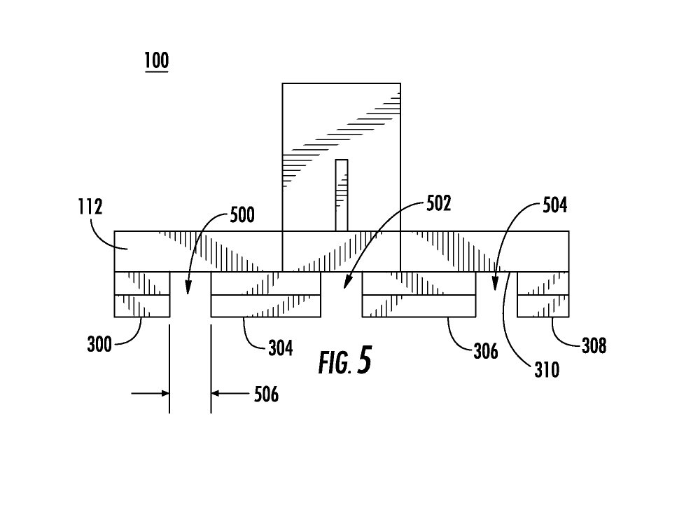

FIG. 5 depicts a top view of the hanger of FIG. 1. The fingers 300-306 of the upper transverse member 112 can be arranged in a spaced manner that defines slots 500, 502, 504 between adjacent pairs of fingers 300-306. Each slot 500-504 can be configured to receive a respective structural support tab of a recycling bin. In this regard, structural support tabs oftentimes are provided on recycling bins to provide structural support for the lip. The slots can have respective widths 506 from about ¼ inch to about ¾ inch, or any other widths suitable for receiving the structural support tabs of the recycling bin. The fingers 320-326 of the lower transverse member 114 (shown in FIG. 3, not shown in FIG. 5) can be spaced apart in a similar manner to define slots between adjacent pairs of fingers 320-326 and configured to receive a respective structural support tab of a recycling bin.

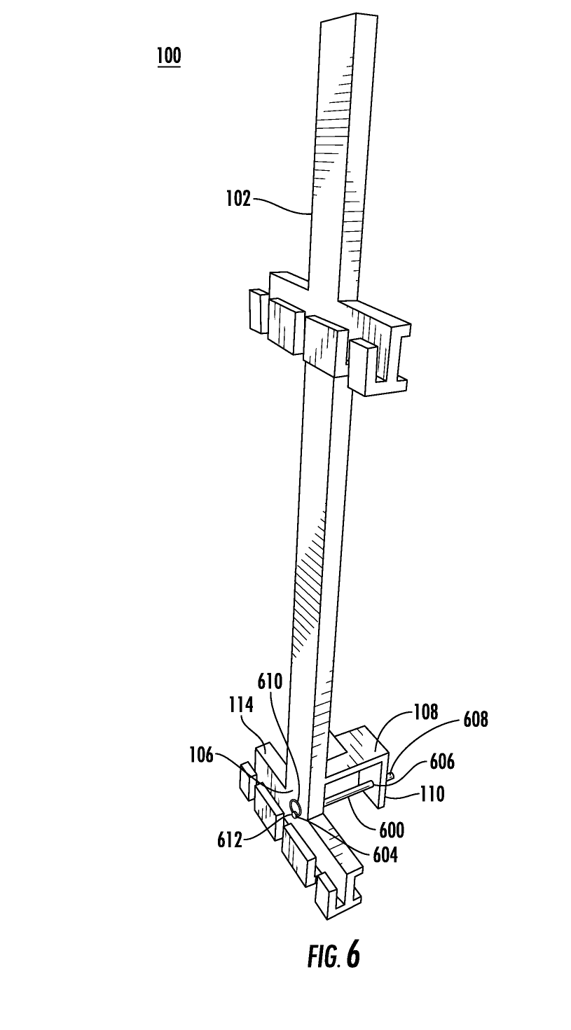

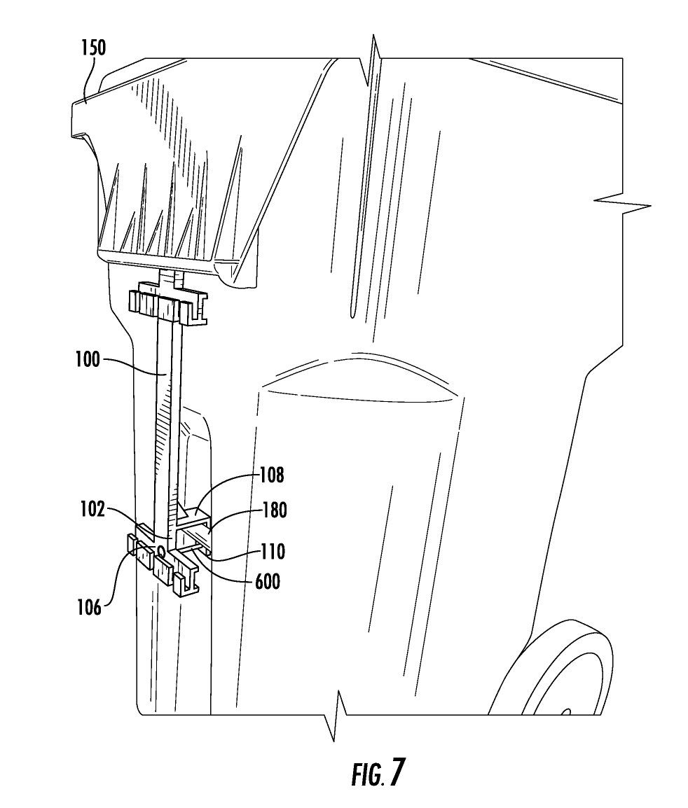

FIG. 6 a perspective view of the hanger 100 of FIG. 1 in accordance with another embodiment disclosed within this specification. In this arrangement, a removable retainer (e.g., pin 600) can be provided to retain the hook 108 to the transverse bar 180 of the garbage container 150 (shown in FIGS. 1 and 2). Specifically, the pin 600 can be removed from the hanger to allow the hook 108 to engage the transverse bar 180 in a manner similar to that described for FIGS. 1 and 2, and inserted into the hanger 100 once the hanger 100 is mounted in place onto the garbage container 150. In illustration, when the hanger 100 is mounted in place, the pin 600 can be inserted into the hanger 100 below the transverse bar 180 to extend at least between the lower portion 106 of the elongated structural member 102 and the tongue 110 of the hook 108. In this regard, when inserted, the pin 600 can enclose the transverse bar 180 between the pin 600, the hook 108 and the elongated structural member 102, as shown in FIG. 7. This can prevent the hanger 100 from being removed from the transverse bar 180, and thus from the garbage container 150, when the pin 600 is in place. The pin can be removed when it is desired to remove the hook 108 from the transverse bar 180 in order to remove the hanger 100 from the garbage container 150.

Referring again to FIG. 6, in one aspect, the hole in the lower portion 106 of the elongated structural member 102 can be positioned approximately where the lower transverse member attaches to the elongated structural member 102. In this arrangement, the tongue 110 of the hook 108 can extend downward a sufficient distance to receive the pin 600. Aligned holes 604, 606 can be provided in the lower portion 106 of the elongated structural member 102 and the tongue 110 of the hook 108, respectively, through which the pin 600 can be inserted. The pin 600 can be held in place with a press fit, for example using spring loaded ball bearing that protrudes through a distal portion 608 of the shaft of the pin 600 beyond where the pin 600 extends through the hook 108. The pin 600 also can include a ring 610 attached to a near end 612 of the pin 600 to facilitate removal of the pin 600 from the hanger 100. The ring 610 can pivot about the end 612 to allow the ring to be moved against the elongated structural member 102 when in place so as to not interfere with the lip of a recycling bin from properly engaging the lower transverse member 114.

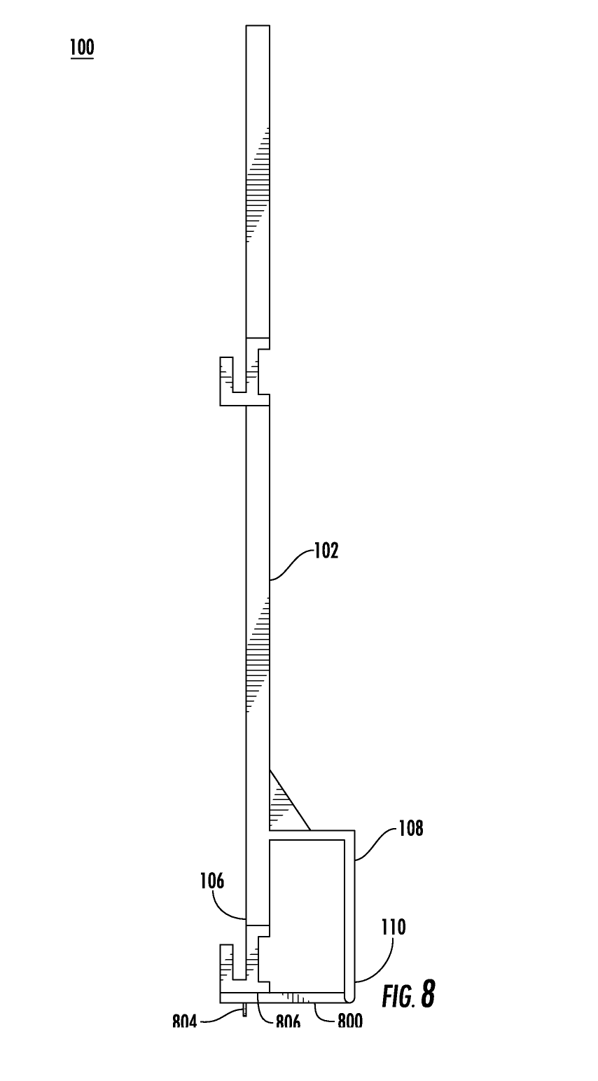

FIG. 8 depicts a side view of the hanger 100 of FIG. 1 in accordance with another embodiment disclosed within this specification. In this arrangement, a retainer (e.g., latch 800) can be provided to retain the hook 108 to the transverse bar 180 of the garbage container 150 (shown in FIGS. 1 and 2). The latch 800 can be operable between a closed position and an open position to selectively connect between the lower portion 106 of the elongated structural member 102 and the tongue 110 of the hook 108. For example, the latch 800 can be hingedly attached to the tongue 110 of the hook. A latch retainer 804, such as fastener, twist lock or other suitable mechanism, can be provided on the bottom 806 of the elongated structural member 102 to retain the latch closed when desired.

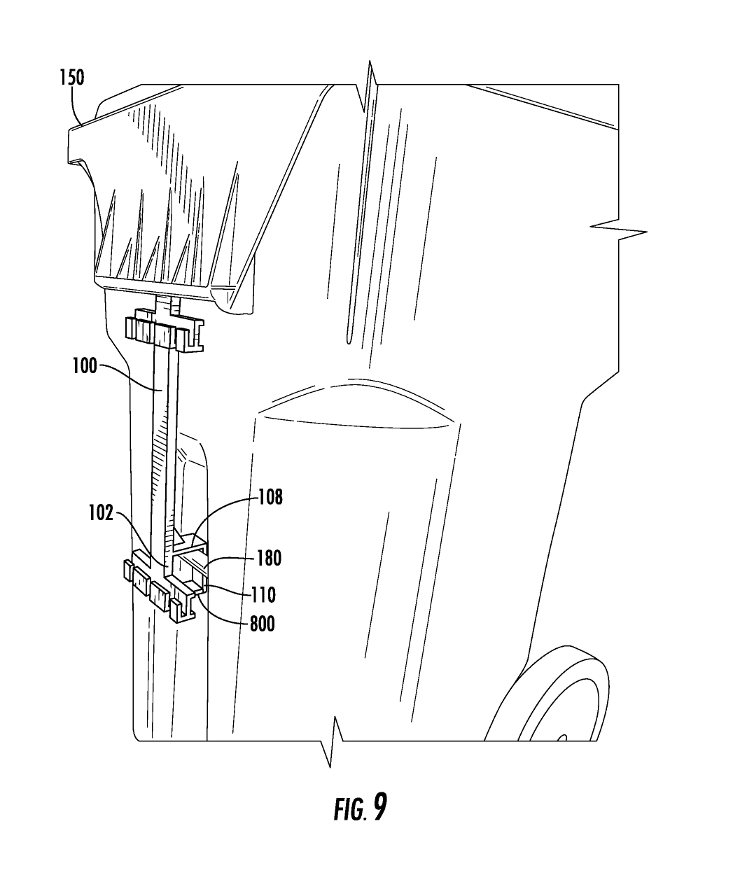

When the latch is open, the hook 108 can be positioned over the transverse bar 180 to mount the hanger 100 to the garbage container 150 in a manner similar to that described for FIGS. 1 and 2. Once the hanger 100 is in place, the latch 800 can be closed and held closed with the latch retainer 804, thus enclosing the transverse bar 180 between the latch 800, the hook 108 and the elongated structural member 102, as shown in FIG. 9. This can prevent the hanger 100 from being removed from the transverse bar 180, and thus from the garbage container 150, when the latch 800 is closed. The latch 800 can be opened when it is desired to remove the hook 108 from the transverse bar 180 in order to remove the hanger 100 from the garbage container 150.

FIG. 10 depicts recycling bins 1002, 1004 supported on the hanger 100 when the hanger is mounted on the garbage container 150. Each recycling bin 1002, 1004 can comprise a respective lip 1006, 1008 that engages a respective transverse member 112, 114. The transverse members 112, 114 engage the recycling bins 1002, 1004, thus supporting the recycling bins 1002, 1004 on the garbage container 150. Notably, the hanger 100 does not interfere with closing of the garbage container's lid 1010. Accordingly, the lid 1010 can be completely closed, and thus contain foul smells that may be emanating from garbage contained in the garbage container 150.

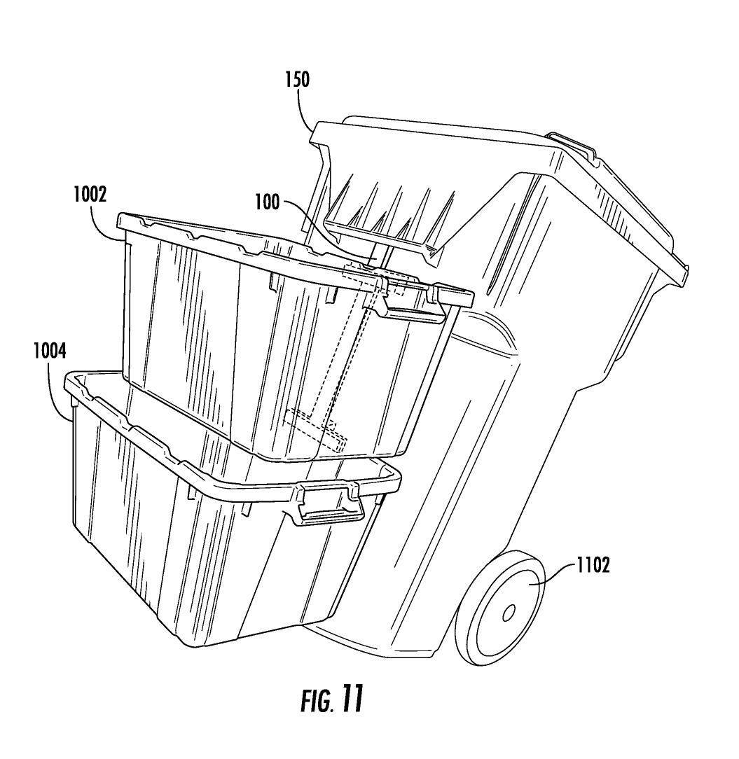

FIG. 11 depicts recycling bins 1002, 1004 supported on (e.g., hung on) the hanger 100 when the hanger 100 is mounted to the garbage container 150 and the garbage container 150 is positioned for movement. In illustration, the garbage container 150 can comprise wheels 1102 to facilitate movement of the garbage container 150 by leaning the garbage container 150 rearward and rolling the garbage container 150 using the wheels 1102. Accordingly, the garbage container 150, with the recycling bins 1002, 1004 attached to the garbage container 150 via the hanger 100, can be moved to a suitable location for garbage and recycling collection.

Since the recycling bins 1002, 1004 are attached to the garbage container 150, movement of the recycling bins 1002, 1004 is facilitated. Specifically, rather than a person making a first trip to move the garbage container 150, a second trip to move the recycling bin 1002, and a third trip to move the recycling bin 1004, the garbage container 150 and recycling bins 1002, 1004 can be moved to a suitable location for garbage and recycling material collection in a single trip, thereby saving a person a significant amount of time and work when moving these structures. Moreover, the user saved from hand carrying the recycling bins 1002, 1004 which sometimes can be fairly heavy when loaded with recyclable items. In this regard, the weight of the recycling bins 1002, 1004 is supported by the garbage container 150 via the hanger 100, and the total weight of the garbage container 150 and recycling bins 1002, 1004 can be balanced on the wheels 1102 to facilitate the movement.

When the garbage container 150 and recycling bins 1002, 1004 are at the appropriate location for garbage/recycling collection, the recycling bins 1002, 1004 can be removed from the hanger 100 and set on the ground, for example next to the garbage container 150. Optionally, the hanger 100 can be easily removed from the garbage container 150 and stored for use later when a person desires to move the garbage container 150 and recycling bins 1002, 1004 back to their original location, or any other desired location, for example after they have been emptied of their contents.

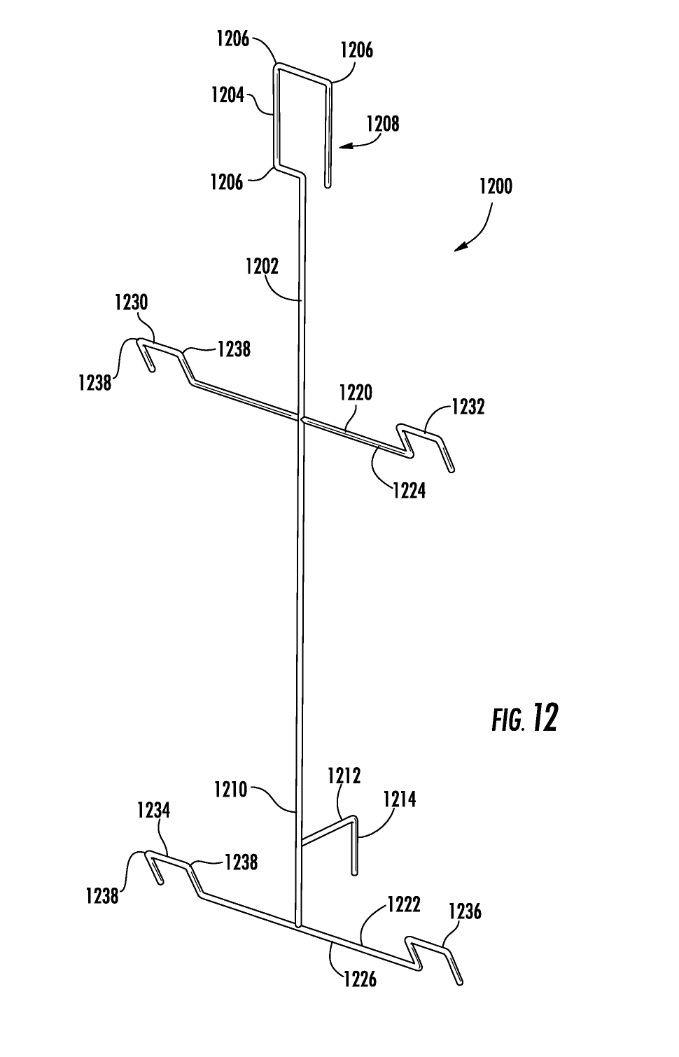

FIG. 12 depicts a perspective view of a hanger 1200 attachable to a garbage container and configured to support recycling bins on the garbage container in accordance with one embodiment disclosed within this specification. The hangar 1200 can be made of a suitable metal, such as the metal wire previously described. The hanger 1200 can include an elongated structural member 1202.

The elongated structural member 1202 can include an upper portion 1204 configured to be received in a cavity (e.g., second cavity 172 of FIG. 1) of a garbage container (e.g., garbage container 150 of FIG. 1) through a downward facing aperture (e.g., aperture 170 of FIG. 1). In one arrangement, the upper portion 1204 can be substantially straight. In another arrangement, the upper portion 1204 can include one or more bends 1206 or curves in the wire to form a tongue 1208.

The elongated structural member 1202 further can include a lower portion 1210. A hook 1212 can extend from the lower portion 1212 of the elongated structural member 1202. More particularly, the hook 1212 can extend from a rear side of the structural member 102. The hook 1212 can be configured to engage a transverse bar of the garbage container (e.g., transverse bar 180 of FIG. 1). For example, the hook can include a downward extending member 1214 that, when the hanger 1200 is mounted on the garbage container, is disposed between the transverse bar and a side member of the garbage container (e.g., side member 184 of FIG. 1) to maintain the position of the hanger 1200 on the garbage container. In one or more arrangements, the hook 1212 can be formed with the structural member 102 as a unitary structure. In one or more arrangements, the hook 1212 can be formed from one or more elements separate from the structural member 1202 and attached thereto in any suitable manner, such as by one or more fasteners, one or more adhesives, one or more forms of mechanical engagement, welding, and/or brazing, just to name a few possibilities.

The hanger 1200 further can include one or more transverse members. For example, the hanger 1200 can include an upper transverse member 1220 and a lower transverse member 1222. The upper and lower transverse members 1220, 1222 can extend from the elongated structural member 1202 in a transverse orientation. The transverse members 1220, 1222 can be configured to engage at least a portion of one or more recycling bins. For example, the upper transverse member can include fingers 1230, 1232 extending upward and outward from a central portion 1224 of the upper transverse member 1220, and configured to receive a lip of a first recycling bin. Similarly, the lower transverse member 122 can include fingers 1234, 1236 extending upward and outward from a central portion 1226 of the lower transverse member 1222, and configured to receive a lip of a second recycling bin. In one arrangement, the fingers 1230-1236 can be substantially straight. In another arrangement, the fingers 1230-1236 can include one or more bends 1238 or curves in the wire to form the fingers 1230-1236.

In one or more arrangements, the upper and/or lower transverse members 1220, 1222 can be formed with the structural member 1202 as a unitary structure. In one or more arrangements, the upper and/or lower transverse members 1220, 1222 can be formed from one or more elements separate from the structural member 1202 and attached thereto in any suitable manner, such as by one or more fasteners, one or more adhesives, one or more forms of mechanical engagement, welding, and/or brazing, just to name a few possibilities. The upper transverse member 1220 can be substantially identical to the lower transverse member 1222. However, in some arrangements, the upper transverse member 1220 can be different from the lower transverse member 1222 in one or more respects.

FIG. 13 is a front view of the hanger 1200 of FIG. 12. A distance 1302 between the fingers 1230, 1232 can be selected so that the fingers 1230, 1232 do not interfere with structural support tabs of a recycling bin when receiving the lip of the recycling bin. Similarly, a distance 1304 between the fingers 1234, 1236 can be selected so that the fingers 1234, 1236 do not interfere with structural support tabs of a recycling bin when receiving the lip of the recycling bin.

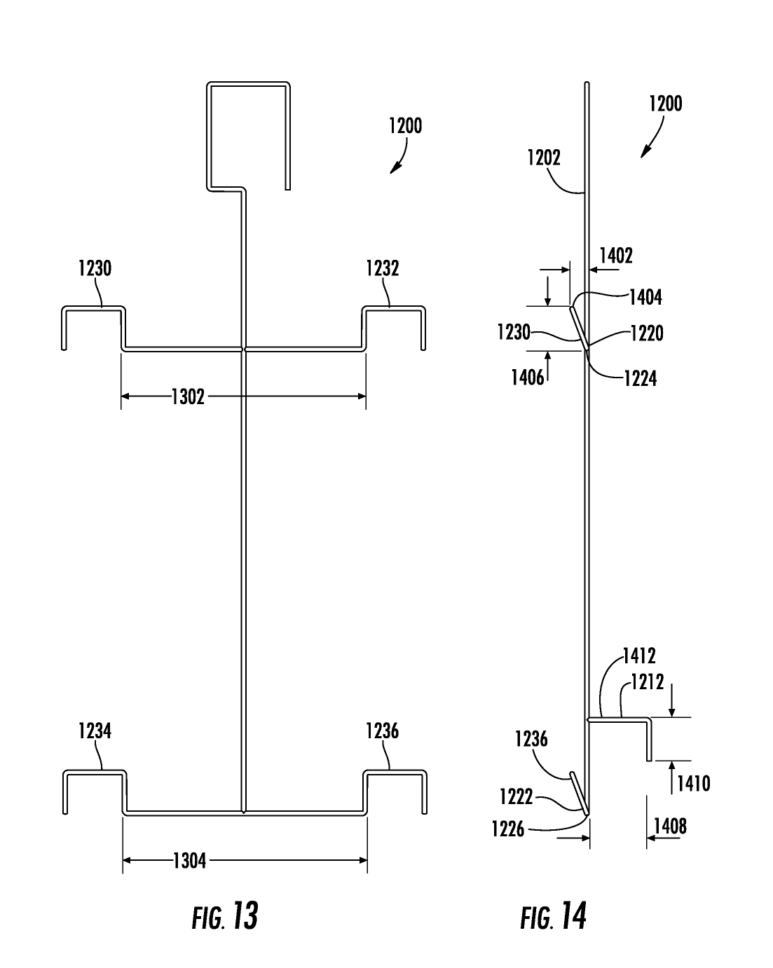

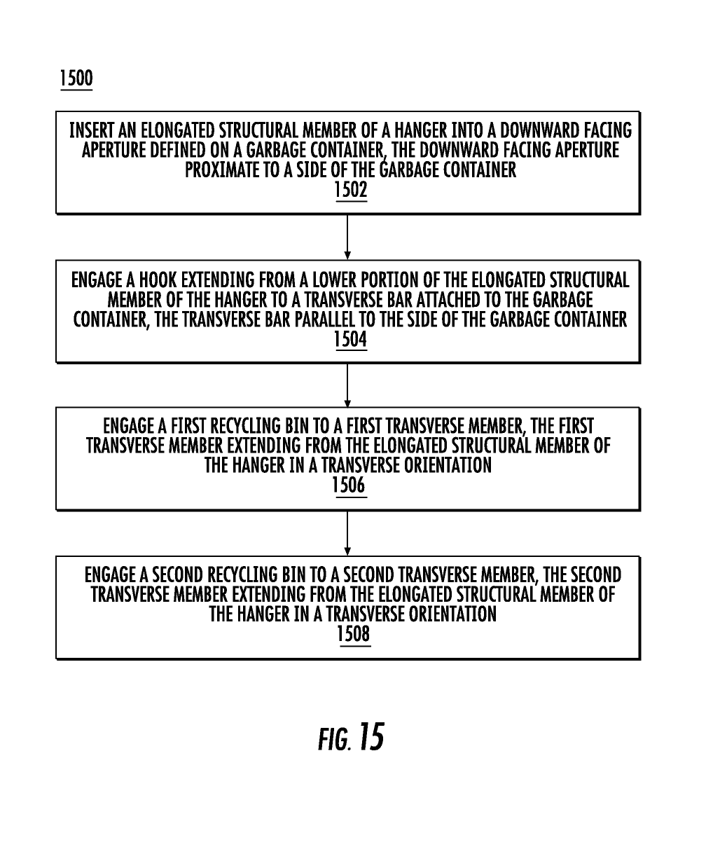

FIG. 14 is a side view of the hanger 1200 of FIG. 12. A distance 1402 an upper portion 1404 of the finger 1230 and finger 1232 (not shown) protrude outward from a plane defined by the structural member 1202 and the central portion 1224 of the upper transverse member 1220 can be, for example, from about ¼inch to about ½ inch, or any other distance suitable for the fingers 1230, 132 to receive the lip of the recycling bin and support the recycling bin when loaded with recycling material. Further, a distance 1406 the upper portion 1404 of the finger 1230 and finger 1232 (not shown) protrude upward from the central portion 1224 of the upper transverse member can be, for example, from about ½ inch to about 1 inch, or any other distance suitable for the fingers 1230, 1232 to receive the lip of the recycling bin and support the recycling bin when loaded with recycling material. The finger 1236 and finger 1234 (not shown) can be configured in a similar manner.

The hook 1212 can extend rearward from the elongated structural member 1202 at any suitable angle. For example, the hook 1212 can extend at an angle of about 90° relative to the structural member 1202. At a distance 1408 from the elongated structural member 1202, the hook 1212 can extend downward at any suitable angle. As an example, the hook 1212 can extend downward at an angle of about 90°. The distance 1408 can be, for example, from about 1.5 inches to about 2.5 inches, though the present arrangements are not limited in this regard. A distance 1410 the hook 1212 extends downward can be, for example, from about 1 inch to about 2 inches, though the present arrangements are not limited in this regard. In other arrangements, the hook 1212 can be parabolic in shape, curved in shape, or have any other shape suitable for engaging the transverse bar 180 (FIG. 1) and holding the hanger 1200 in place when recycling bins are supported on the hanger 1200.

The lower transverse member 1222 on the elongated structural member 1202 and the hook 1212 can have any suitable position relative to each other. In one arrangement, the position of the lower transverse member 1222 on the elongated structural member 1202 can be lower than a position of the hook 1212 on the elongated structural member 1202, though this need not be the case. In illustration, the central portion 1226 of the lower transverse member can be spaced from about 2.5 inches to about 3.5 inches from an upper portion 1412 of the hook 1212.

FIG. 15 is a flowchart illustrating an example of a method 1500 of attaching a recycling bin to garbage container. At step 1502, an elongated structural member of a hanger can be inserted into a downward facing aperture defined on a garbage container, the downward facing aperture proximate to a side of the garbage container. At step 1504, a hook extending from a lower portion of the elongated structural member of the hanger can be engaged to a transverse bar attached to the garbage container, the transverse bar parallel to the side of the garbage container. At step 1506, a first recycling bin can be engaged to a first transverse member, the first transverse member extending from the elongated structural member of the hanger in a transverse orientation. At step 1508, a second recycling bin can be engaged to a second transverse member, the second transverse member extending from the elongated structural member of the hanger in a transverse orientation.

Like numbers have been used to refer to the same items throughout this specification. The terminology used herein is for the purpose of describing particular embodiments only and is not intended to be limiting of the invention. The terms “a” and “an,” as used herein, are defined as one or more than one. The term “plurality,” as used herein, is defined as two or more than two. The term “another,” as used herein, is defined as at least a second or more. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

Reference throughout this specification to “one arrangement,” “an arrangement,” or similar language means that a particular feature, structure, or characteristic described in connection with the embodiment is included in at least one arrangement disclosed within this specification. Thus, appearances of the phrases “in one arrangement,” “in an arrangement,” and similar language throughout this specification may, but do not necessarily, all refer to the same arrangement.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

These embodiments can be embodied in other forms without departing from the spirit or essential attributes thereof. Accordingly, reference should be made to the following claims, rather than to the foregoing specification, as indicating the scope of the embodiments.

What is claimed is:

1. A hanger comprising:
an elongated structural member comprising an upper portion configured to insert through a downward facing aperture defined on a garbage container proximate to a side of the garbage container;
a hook extending from a lower portion of the elongated structural member, the hook configured to engage a transverse bar attached to the garbage container; and
a first transverse member extending from the elongated structural member in a transverse orientation, the first transverse member configured to engage a first recycling bin.

2. The hanger of claim 1, further comprising:
a second transverse member extending from the elongated structural member in a transverse orientation, the second transverse member configured engage a second recycling bin.

3. The hanger of claim 2, wherein the first transverse member is located on the elongated structural member at a first position and the second transverse member is located on the elongated structural member at a second position, a vertical distance between the first position and the second position being at least equal to a height of the first recycling bin.

4. The hanger of claim 2, wherein:
the first transverse member comprises a plurality of first fingers configured to engage a lip of the first recycling bin; and
the second transverse member comprises a plurality of second fingers configured to engage a lip of the second recycling bin.

5. The hanger of claim 4, wherein:
a first slot is defined between each pair of adjacent first fingers, each first slot configured to receive a respective structural support tab of the first recycling bin, wherein each structural support tab provides structural support for the lip of the first recycling bin.
a second slot is defined between each pair of adjacent second fingers, each second slot configured to receive a respective structural support tab of the second recycling bin, wherein each structural support tab provides structural support for the lip of the second recycling bin.

6. The hanger of claim 1, wherein the first transverse member comprises a plurality of fingers configured to engage a lip of the first recycling bin.

7. The hanger of claim 6, wherein a first slot is defined between each pair of adjacent fingers, each first slot configured to receive a respective structural support tab of the first recycling bin, wherein each structural support tab provides structural support for the lip of the first recycling bin.

8. The hanger of claim 1, further comprising:
a pin operable between an inserted position and a removed position to selectively extend at least between the lower portion of the elongated structural member and a tongue of the hook, the pin configured to retain the hook to the transverse bar of the garbage container when the pin is inserted to extend at least between the lower portion of the elongated structural member and the tongue of the hook, the hook being removable from the transverse bar when the pin is removed.

9. The hanger of claim 1, further comprising:
a latch operable between a closed position and an open position to selectively connect between the lower portion of the elongated structural member and a 1 tongue of the hook, the latch configured to retain the hook onto the transverse bar of the garbage container when the latch is in the closed position, the hook being removable from the transverse bar when the latch is in the open position.

10. A hanger comprising:
an elongated structural member comprising an upper portion configured to insert through a downward facing aperture defined on a garbage container proximate to a side of the garbage container;
a hook extending from a lower portion of the elongated structural member, the hook configured to engage a transverse bar attached to the garbage container, the hook including a retainer to selectively retain the transverse bar;
a first transverse member extending from the elongated structural member in a transverse orientation, the first transverse member configured to engage a first recycling bin; and
a second transverse member extending from the elongated structural member in a transverse orientation, the second transverse member configured engage a second recycling bin.

11. The hanger of claim 10, wherein the retainer is a pin operable between an inserted position and a removed position to selectively extend at least between the lower portion of the elongated structural member and a tongue of the hook, the pin configured to retain the hook to the transverse bar of the garbage container when the pin is inserted to extend at least between the lower portion of the elongated structural member and the tongue of the hook, the hook being removable from the transverse bar when the pin is removed.

12. A method comprising:
inserting an elongated structural member of a hanger into a downward facing aperture defined on a garbage container, the downward facing aperture proximate to a side of the garbage container;
engaging a hook extending from a lower portion of the elongated structural member of the hanger to a transverse bar attached to the garbage container, the transverse bar parallel to the side of the garbage container; and
engaging a first recycling bin to a first transverse member, the first transverse member extending from the elongated structural member of the hanger in a transverse orientation.

13. The method of claim 12, further comprising:
engaging a second recycling bin to a second transverse member, the second transverse member extending from the elongated structural member of the hanger in a transverse orientation.

14. The method of claim 13, wherein the first transverse member is located on the elongated structural member at a first position and the second transverse member is located on the elongated structural member at a second position, a distance between the first position and the second position being at least equal to a height of the first recycling bin.

15. The method of claim 13, wherein:
the first transverse member comprises a plurality of first fingers configured to engage a lip of the first recycling bin; and
the second transverse member comprises a plurality of second fingers configured to engage a lip of the second recycling bin.

16. The method of claim 15, wherein:
a first slot is defined between each pair of adjacent first fingers, each first slot configured to receive a respective structural support tab of the first recycling bin, wherein each structural support tab provides structural support for the lip of the first recycling bin.
a second slot is defined between each pair of adjacent second fingers, each second slot configured to receive a respective structural support tab of the second recycling bin, wherein each structural support tab provides structural support for the lip of the second recycling bin.

17. The method of claim 12, wherein the first transverse member comprises a plurality of fingers configured to engage a lip of the first recycling bin.

18. The method of claim 17, wherein a first slot is defined between each pair of adjacent fingers, each first slot configured to receive a respective structural support tab of the first recycling bin, wherein each structural support tab provides structural support for the lip of the first recycling bin.

19. The method of claim 12, further comprising:
inserting a pin to extend at least between the lower portion of the elongated structural member and a tongue of the hook, the pin configured to retain the hook to the transverse bar of the garbage container when the pin is inserted to extend at least between the lower portion of the elongated structural member and the tongue of the hook, the hook being removable from the transverse bar when the pin is removed.

20. The method of claim 12, further comprising:
closing a latch from an open position to a closed position to connect the latch between the lower portion of the elongated structural member and a tongue of the hook, the latch configured to retain the hook onto the transverse bar of the garbage container when the latch is in the closed position, the hook being removable from the transverse bar when the latch is in the open position.
